(19) United States
(12) Patent Application Publication
(10) Pub. No.: US 2011/0238296 A1
(43) Pub. Date: Sep. 29, 2011

(54) Computer order handling system providing transferrable order delivery through networked electronic kiosks

(76) Inventors: Connor Kent Purks, Cary, NC (US); Kory Patrick Purks, Cary, NC (US); Bryce Benjamin Purks, Cary, NC (US); Deborah Rhea Purks, Cary, NC (US); David Kent Purks, Cary, NC (US)

(21) Appl. No.: 13/066,991

(22) Filed: Apr. 29, 2011

(51) Int. Cl. G06Q 30/00; G01C 21/00

(52) U.S. Cl. 701/201; 705/26.9; 705/26.7

(57) ABSTRACT

An order handling system includes a network interface and an order handling module. The network interface communicates through a wide area network with a plurality of kiosks. The order handling module is configured to receive, via the network interface, an order from a user for a first item that is within the inventory of a first kiosk. The order handling module is further configured to reserve the first item for pick-up by the user at the first kiosk in response to the order. After the first item is reserved for pick-up, the order handling module receives from a second kiosk an order inquiry from the user, where the second kiosk is geographically spaced apart from the first kiosk. The order handling module is configured to determine that the user is located at the second kiosk instead of at the first kiosk where the first item is reserved, and, responsive that determination, to carry out through the second kiosk operations that display to the user the relative geographic locations of the first and second kiosks and/or a third kiosk that contains the first item, and/or operations that transfer the order for completion at the second kiosk or another kiosk that is selected by user through the second kiosk.

### FIELD OF THE INVENTION

This invention relates to order handling systems, and more particularly to apparatuses and methods for operating kiosk-based order delivery systems.

### BACKGROUND OF THE INVENTION

Order handling systems have been developed in which a user can order a movie, video game, or other item through the Internet and then pick-up the ordered item at a particular kiosk selected by the user. For example, Redbox, Blockbuster, and other vendors operate tens of thousands of movie and video game rental/sales kiosks that are distributed across the United States and internationally. To order a movie/game, a user operates a web-browser on a computer terminal to access, through a wide area network (e.g., Internet), the vendor's order handling server, to search through the movies/games that are available from the vendor (e.g., Redbox or Blockbuster), and to select a movie/game that the user wants to rent or buy. The user enters a local address and the order handling server responds by identifying near-by kiosks that presently have the selected item in their inventory. The user selects one of the identified kiosks, provides payment information to pay for the selected item, and then the selected item is reserved from the inventory of the selected kiosk for the user to pick-up.

Upon arriving at the selected kiosk, the user may swipe a credit card or enter other information that identifies the user. The kiosk verifies the order and delivers the ordered item to the user from the local inventory of the kiosk.

### SUMMARY OF THE INVENTION

The present inventors have identified significant flaws with present order handling servers and networked kiosks. Once a user has selected a kiosk and provided payment information, the selected item is reserved for pick-up by the user exclusively at the selected kiosk location. However, the selected kiosk location cannot be subsequently changed. Moreover, the user may have a limited time-window (e.g., 12 hours) to pick-up the item from the selected kiosk location before the reservation is canceled and the selected item is made available for rental/sale to another user from the selected kiosk without refund to the user. Consequently, if the user forgets which kiosk was selected, erroneously travels to the wrong kiosk, or observes another closer kiosk while traveling to the selected kiosk, the user must still travel to the selected kiosk to receive the selected item before the reservation expires.

With the substantial proliferation of kiosks in stores, restaurants, gas stations, etc., substantial competitive advantages and user satisfaction would be achieved by providing improved operations for order handling systems and networked kiosks.

Various embodiments of the present invention are directed an order handling system that includes a network interface and an order handling module. The network interface is configured to communicate through a wide area network. The order handling module is configured to receive, via the network interface, an order from a user for a first item that is within the inventory of a first kiosk. The order handling module is further configured to reserve the first item for pick-up by the user at the first kiosk in response to the order. After the first item is reserved for pick-up, the order handling module receives from a second kiosk an order inquiry from the user, where the second kiosk is geographically spaced apart from the first kiosk. The order handling module is configured to determine that the user is located at the second kiosk instead of at the first kiosk where the first item is reserved, and, responsive that determination, to carry out through the second kiosk one of:
1) displaying to the user, through the second kiosk, a geographic location of the first kiosk;
2) in response to the first item not being in the inventory of the second kiosk, identifying that a third kiosk has the first item within its inventory and displaying at the second kiosk a geographic location of the third kiosk;
3) in response to the first item not being in the inventory of the second kiosk, delivering the first item from the second kiosk to the user to complete the order; or
4) in response to the first item not being in the inventory of the second kiosk, displaying at the second kiosk an offer to deliver a second item that is within the inventory of the second kiosk and, in response to the user accepting the offer, delivering the second item to the user to complete the order, wherein the second item is different than the first item.

Some other embodiments are directed to a first kiosk that includes a network interface, a display device, a user input interface, an item inventory handling apparatus, an item delivery apparatus, and an order handing module. The network interface is configured to communicate through a wide area network. The item inventory handling apparatus is configured to organize a plurality of items. The item delivery apparatus is configured to receive items from some users and store the received items in the item inventory handling apparatus, and to delivery items from the item inventory handling apparatus to other users. The order handling module that is configured to receive an order inquiry from a user via the user input interface. The order handling module is further configured to respond to a determination that the user placed an order to pick-up a first item from a second kiosk that is geographically spaced apart from the first kiosk, by performing one of:
1) displaying to the user, through the display device, driving directions from the first kiosk to the second kiosk;
2) in response to the first item not being in the inventory of the first kiosk, identifying that a third kiosk has the first item within its inventory and displaying at the first kiosk a geographic location of the third kiosk;
3) in response to the first item being in the inventory of the first kiosk, delivering the first item from the first kiosk to the user to complete the order; or
4) in response to the first item not being in the inventory of the first kiosk, displaying at the first kiosk an offer to deliver a second item that is within the inventory of the first kiosk and, in response to the user accepting the offer, delivering the second item to the user to complete the order, wherein the second item is different than the first item.

Additional systems, apparatuses, and methods according to other embodiments of the invention will be or become apparent to one of skill in the art upon review of the following drawings and Detailed Description. It is intended that all such additional systems, apparatuses, and methods be included within this description, be within the scope of the present invention, and be protected by the accompanying claims.

### BRIEF DESCRIPTION OF THE DRAWINGS

The accompanying drawings, which are included to provide a further understanding of the invention and are incorporated in and constitute a part of this application, illustrate certain embodiments of the invention. In the drawings:

FIG. 1 illustrates example order handling system according to some embodiments of the present invention;

FIG. 2 illustrates an example electronic item delivery kiosk according to some embodiments of the present invention;

FIG. 3 illustrates a map that is displayed on a display device of a second kiosk which informs a user of the location of a first kiosk where the ordered item is awaiting pick-up and may further inform the user as to the location of other nearby kiosks where the order for the item can be transferred for pick-up, according to some embodiments of the present invention;

FIG. 4 illustrates driving directions that are displayed on a display device of a second kiosk which inform a user how to drive from the second kiosk location to a first kiosk location where the ordered item is awaiting pick-up, according to some embodiments of the present invention;

FIG. 5 illustrates an operation and communication flow diagram that shows example operations and methods that may be performed by the order handling system of FIG. 1 or another order handling system, according to some embodiments of the present invention;

FIG. 6 illustrates an operation and communication flow diagram that shows example operations and methods that may be performed by the order handling system of FIG. 1 in combination with the operations and methods of FIG. 5 to transfer an order by a user to pick-up a first item at a first kiosk to instead pick-up the first item at a second kiosk to complete the order, according to some embodiments of the present invention;

FIG. 7 illustrates an operation and communication flow diagram that shows example operations and methods that may be performed by the order handling system of FIG. 1 in combination with the operations and methods of FIG. 5 to transfer an order by a user to pick-up a first item at a first kiosk to instead picked up a different second item at a second kiosk to complete the order, according to some embodiments of the present invention; and

FIG. 8 illustrates an operation and communication flow diagram that shows example operations and methods that may be performed by the order handling system of FIG. 1 in combination with the operations and methods of FIG. 5 to transfer an order by a user to pick-up a first item at a first kiosk to instead pick-up the first item at a third kiosk, which is separate from a second kiosk where the user is presently located, to complete the order, according to some embodiments of the present invention.

### DETAILED DESCRIPTION

Embodiments of the present invention now will be described more fully hereinafter with reference to the accompanying drawings, in which embodiments of the invention are shown. This invention may, however, be embodied in many different forms and is not to be construed as limited to the embodiments set forth herein.

The present inventors have identified significant flaws with present order handling servers and networked kiosks. Once a user has selected a kiosk and provided payment information, the selected item is reserved for pick-up by the user exclusively at the selected kiosk location, and which location cannot be subsequently changed. Moreover, the user may have a limited time-window (e.g., 12 hours) to pick-up the item from the selected kiosk location before the reservation is canceled and the selected item is made available for rental/sale to another user from the selected kiosk without refund to the user. Consequently, if the user forgets what kiosk was selected, erroneously travels to the wrong kiosk, or observes another closer kiosk while traveling to the selected kiosk, the user must still track-down and travel to the selected kiosk to receive the selected item before the reservation expires.

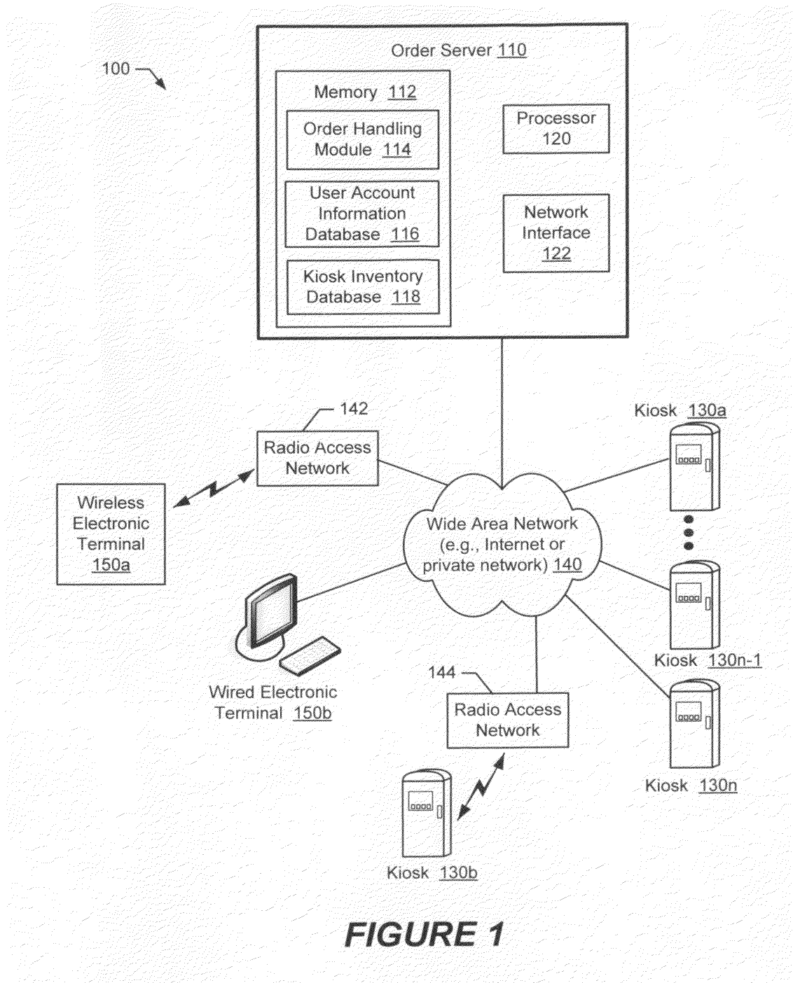

FIG. 1 illustrates an example order handling system 100 according to some embodiments of the present invention. Referring to FIG. 1, the system 100 may include an order handling server 110 that communicates with a plurality of kiosks 130a-103n (where n is a plural number) and a plurality of user electronic terminals 150a,150b that are operated by users. The order server 110 communicates with the kiosks 130a-130n and the electronic terminals 150a/150b through a wide area network 140, which may include a public data network, such as the Internet, and/or a private data network. Communications between the wide area network 140 and one or more of the electronic terminals and/or the kiosks may occur through one or more radio access networks 142,144. For example, the electronic terminal 150a and/or the kiosk 130b may communicate through a wireless air interface to the wide area network 140 and the order server 110.

The radio access networks 142,144 may communicate with the electronic terminal 150a and/or the kiosk 130b, respectively, using one or more cellular radio access technology interfaces that may include Global Standard for Mobile (GSM) communication interface, General Packet Radio Service (GPRS) interface, enhanced data rates for GSM evolution (EDGE) interface, DCS interface, PDC interface, PCS interface, code division multiple access (CDMA) interface, wideband-CDMA interface, CDMA2000 interface, Universal Mobile Telecommunications System (UMTS) interface, and/or 3GPP LTE (3rd Generation Partnership Project Long Term Evolution) interface. The communications may additionally or alternatively occur using a Wireless Local Area Network (i.e., IEEE 802.11) interface, a Bluetooth interface, and/or another wireless communication interface.

The order server 110 is configured to receive orders from users for items that are contained in the inventory of various ones of the kiosks 130a-130n. For example, a user can order a movie, video game, electronic item, food item, or other item through an electronic terminal (e.g., terminal 150a) and then pick-up the ordered item at a particular kiosk selected by the user (e.g., kiosk 130a). The kiosks may, for example, contain movies and/or video games that can be rented or purchased by users through the order server 110. Alternatively or additionally, the kiosks may contain electronic or other products (e.g., music players and/or accessories, phone accessories, etc.) that can be rented or purchased by users through the order server 110. The kiosks may be configured to dispense food items. Accordingly, the kiosks may correspond to kiosks that could be operated by Redbox, Blockbuster, Best Buy, or other vendors, but which are configured to provide enhanced operational functionality according to one or more embodiments disclosed herein.

The electronic terminals 150a,150b may include, but are not limited to, cellular phones, desktop computers, laptop computers, tablet computers, palmtop computers, or any other communication terminal that can be operated by a user to communicate with the order server 110 to purchase or rent an item that is within the inventory of one or more of the kiosks 130a-130n.

Although only 4 kiosks have been illustrated in FIG. 1 for ease of illustration, it is to be understood that tens of thousands of the kiosks may be distributed across the United States and internationally (e.g., at grocery stores, gas stations, department stores, shopping malls, banks, airport terminals, etc.). Moreover, although only 2 electronic terminals have been illustrated in FIG. 1 for ease of illustration, it is to be understood that the order server 110 may communicate with any number of users via any number of electronic terminals to setup orders for delivery of items through the kiosks. Moreover, it is to be understood that system 100 of FIG. 1 is a non-limited example. Although various embodiments are described herein in the context of a centralized order server 110, is to be understood that at least some or all of the functionality described herein for the order server 110 may be performed by one or more of the kiosks 130a-n. Thus, functionality of the order handling module 114, the user account information database 116, and/or the kiosk inventory database 118 may be partially or wholly performed by and reside in one, some, or all of the kiosks 130a-n.

The order server 110 can include a processor circuit 120, memory device(s) 112, and a network interface 122. The processor circuit 120 may include one or more data processing circuits, such as a general purpose and/or special purpose processor (e.g., microprocessor and/or digital signal processor) with on-board and/or separate memory devices. The processor circuit 120 is configured to execute computer program instructions in functional modules within the memory device(s) 112, which is described below as a computer readable medium, to operate as described herein. The network interface 122 is configured to communicate with the electronic terminals 150a,150b and the kiosks 130a-n through the network 140 and/or the radio access network(s) 142/144.

The memory device(s) 112 contain functional modules, which may include an order handling module 114, a user account information database 116, and a kiosk inventory database 118. The user account information database 116 can contain account information for users, including, for example, payment information (e.g., credit card and/or bank draft information for the users), user identifiers and associated login credentials, home mailing addresses, and/or email addresses. The kiosk inventory database 118 can maintain a listing of the items that are presently within the inventory of each of the kiosks 130a-n. The order handling module 114 can be configured to perform operations to receive account information for a user, to enable a user to place an order for an item within the inventory of one or more of the kiosks 130a-n, to identify one or more of the kiosks 130a-n that contains the item selected by the user, and to reserve the item from the inventory of one of the kiosks 130a-n selected by the user for pick-up by the user at the selected kiosk.

For example, to order a movie/game/product or other item, a user may operate a web-browser on an electronic terminal 150 to interact, through the wide area network 140 and/or the radio access networks 142/144, with the order handling module 114 on the order server 110, to search through the movies/games/products or other items that are available from the vendor (e.g., Redbox, Blockbuster, Best Buy, etc.), and to select an item that the user wants to rent or buy. The user enters a local address and the order handling module 114 uses the address to identify near-by kiosks 130 that presently have the selected item in their inventory. The user selects one of the identified kiosks 130, provides payment information to pay for the selected item, and then the order handling module 114 reserves the selected item from the inventory of the selected kiosk (e.g., kiosk 130a) for the user to pick-up at the selected kiosk.

In accordance with embodiments of the present invention, if the user forgets which kiosk (e.g., kiosk 130a) was selected for pick-up of the item, if the user erroneously travels to a kiosk (e.g., kiosk 130b) other than the selected kiosk (e.g., kiosk 130a), and/or if the user observes another closer kiosk (e.g., kiosk 130n−1) while traveling to the selected kiosk (e.g., kiosk 130a), the user can interact with the order handling module 114 of the order server 110 through a kiosk (e.g., kiosk 130n−1) other than the selected kiosk (e.g., kiosk 130a) to assist the user with completion of the order.

In some embodiments of the present invention, the order handling module 114 is configured to receive, via the network interface 122, an order from a user (e.g., via electronic terminal 150a) for a first item that is within the inventory of a first kiosk (e.g., kiosk 130a). The order handling module 114 is further configured to reserve the first item for pick-up by the user at the first kiosk (e.g., kiosk 130a) in response to the order. After the first item is reserved for pick-up, the order handling module 114 receives from a second kiosk (e.g., kiosk 130b) an order inquiry from the user, where the second kiosk (e.g., kiosk 130b) is geographically spaced apart from the first kiosk (e.g., kiosk 130a). The order handling module 114 is configured to determine that the user is located at the second kiosk (e.g., kiosk 130b) instead of at the first kiosk (e.g., kiosk 130a) where the first item is reserved, and, responsive that determination, to carry out through the second kiosk (e.g., kiosk 130b) one of:
1) displaying to the user, through the second kiosk (e.g., kiosk 130b), a geographic location of the first kiosk (e.g., kiosk 130a);
2) in response to the first item not being in the inventory of the second kiosk (e.g., kiosk 130b), identifying that a third kiosk (e.g., kiosk 130n) has the first item within its inventory and displaying at the second kiosk (e.g., kiosk 130b) a geographic location of the third kiosk (e.g., kiosk 130n);
3) in response to the first item being in the inventory of the second kiosk (e.g., kiosk 130b), delivering the first item from the second kiosk (e.g., kiosk 130b) to the user to complete the order; or
4) in response to the first item not being in the inventory of the second kiosk (e.g., kiosk 130b), displaying at the second kiosk (e.g., kiosk 130b) an offer to deliver a second item that is within the inventory of the second kiosk (e.g., kiosk 130b) and, in response to the user accepting the offer, delivering the second item to the user from the second kiosk (e.g., kiosk 130b) to complete the order, where the second item is different than the first item.

As defined by the previous paragraph, the order handling module 114 performs at least one of the first through fourth enumerated operations. However, the order handling module 114 is not restricted to being capable of performing more than one of the first through fourth enumerated operations.

Thus, it is to be understood that the order handling module 114 may be configured in one embodiment to perform the first enumerated operation (i.e., displaying to the user, through the second kiosk (e.g., kiosk 130b), a geographic location of the first kiosk (e.g., kiosk 130a)) while being entirely devoid of any capability to perform any of the second through fourth enumerated operations. The order handling module 114 may be configured to display to the user, through a display device of the second kiosk (e.g., kiosk 130b), geographic locations of the first kiosk (e.g., kiosk 130a) and second kiosk (e.g., kiosk 130b) relative to an electronic map of roads. The order handling module 114 may be configured to identify that the first item is not in the inventory of the second kiosk (e.g., kiosk 130b), and to respond to the inventory identification and to the determination that the user is located at the second kiosk (e.g., kiosk 130b) by displaying on the display device of the second kiosk (e.g., kiosk 130b) to the user driving directions from the second kiosk (e.g., kiosk 130b) to the first kiosk (e.g., kiosk 130a).

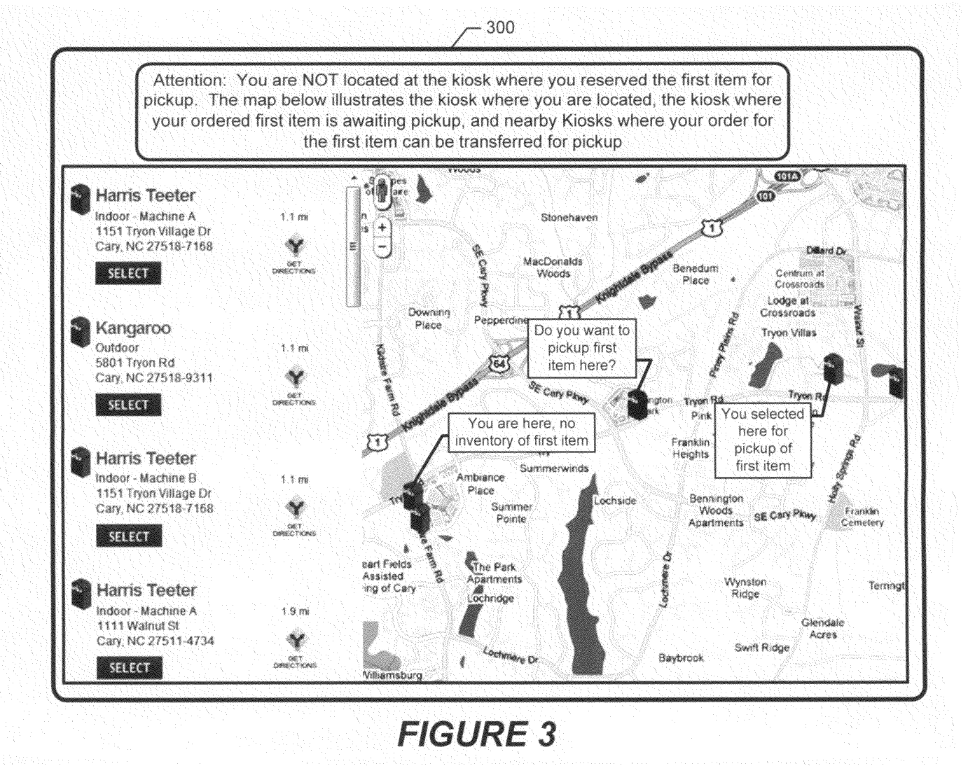

FIG. 3 illustrates an example map that may be displayed on a display device of the second kiosk (e.g., kiosk 130b) which informs a user of the location of a first kiosk (e.g., kiosk 130a) where the ordered item is awaiting pick-up and may further inform the user as to the location of other nearby kiosks (e.g., kiosks 130n−1, 130n, . . . ) where the order for the item can be transferred for pick-up, according to some embodiments of the present invention. Referring to FIG. 3, the second kiosk (e.g., kiosk 130b) displays an example informational message responsive to the determination that the user is located at the second kiosk (e.g., kiosk 130b) which is not the first kiosk (e.g., kiosk 130a) where the user reserved the first item for pick-up and responsive to the further determination that the second kiosk (e.g., kiosk 130b) does not contain the first item in its inventory. The example message may read as follows:
“Attention: You are NOT located at the kiosk where you reserved the first item for pick-up. The map below illustrates the kiosk where you are located, the kiosk where your ordered first item is awaiting pick-up, and nearby kiosks where your order for the first item can be transferred for pick-up.”

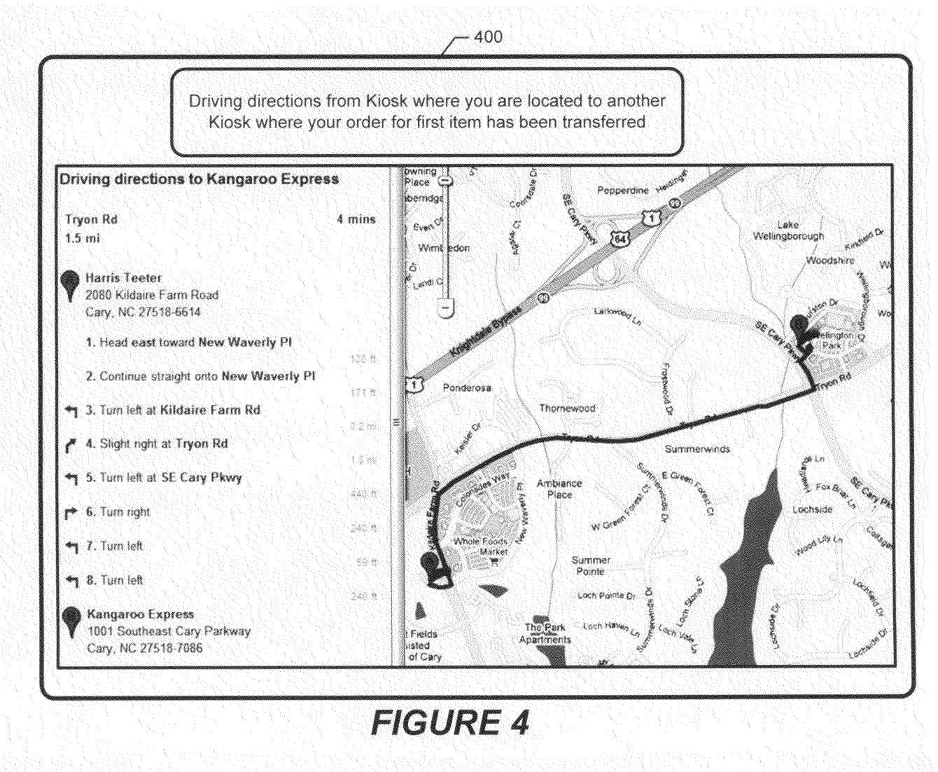

FIG. 4 illustrates an example map that may be displayed on a display device of the second kiosk (e.g., kiosk 130b) which informs a user of driving directions from the second kiosk (e.g., kiosk 130b) location to the first kiosk (e.g., kiosk 130a) location where the ordered item is awaiting pick-up, according to some embodiments of the present invention. When the user selects another kiosk (e.g., kiosk 130n) where the order is to be transferred for pick-up, the driving directions that are displayed to the user may be from the second kiosk (e.g., kiosk 130b) to the other kiosk (e.g., kiosk 130n).

The order handling module 114 may access the kiosk inventory database 118 to determine whether the first item is within the inventory of the second kiosk (e.g., kiosk 130b) and/or whether it is within the inventory of another one of the kiosks (e.g., kiosks 130n−1,130n, . . . ). The kiosk inventory database 118 may include information that identifies the location (e.g., street address and/or GPS coordinates) of each of the kiosks 130a-n.

Likewise, the order handling module 114 may be configured according to another embodiment to perform the second enumerated operation (i.e., in response to the first item not being in the inventory of the second kiosk (e.g., kiosk 130b), identifying that a third kiosk (e.g., kiosk 130n) has the first item within its inventory and displaying at the second kiosk (e.g., kiosk 130b) a geographic location of the third kiosk (e.g., kiosk 130n)) while being entirely devoid of any capability to perform any of the first, third, and fourth enumerated operations. The order handling module 114 may be configured to display to the user, through the display device of the second kiosk (e.g., kiosk 130b), driving directions from the second kiosk (e.g., kiosk 130b) to the third kiosk (e.g., kiosk 130n). The order handling module 114 may be configured to offer to reserve the first item at the third kiosk (e.g., kiosk 130n) for pick-up by the user and, responsive to the user accepting the offer (e.g., by operating the electronic terminal 150a), to reserve the first item at the third kiosk (e.g., kiosk 130n) and to cancel the user's reservation for the first item at the first kiosk (e.g., kiosk 130a).

The order handling module 114 may update the kiosk inventory database 118 to reserve the first item from the inventory of third kiosk (e.g., kiosk 130n) for pick-up by the user and to cancel the reservation for the first item from the inventory of the first kiosk (e.g., kiosk 130a) so that the first item is available for reservation pursuant to a subsequent order from the same or another user.

According to another embodiment, the order handling module 114 may be configured to perform the third enumerated operation (i.e., in response to the first item being in the inventory of the second kiosk (e.g., kiosk 130b), delivering the first item from the second kiosk (e.g., kiosk 130b) to the user to complete the order) while being entirely devoid of any capability to perform any of the first, second, and fourth enumerated operations. When the first item is delivered to the user from the inventory of the second kiosk (e.g., kiosk 130b), the kiosk inventory database 118 can be updated to remove the delivered first item from the inventory of the second kiosk (e.g., kiosk 130b), and to cancel the reservation for the first item from then inventory of the first kiosk (e.g., kiosk 130a) so that it is available for reservation pursuant to a subsequent order for that item from the first kiosk (e.g., kiosk 130a).

According to another embodiment, the order handling module 114 may be configured to perform the fourth enumerated operation (i.e., in response to the first item not being in the inventory of the second kiosk (e.g., kiosk 130b), displaying at the second kiosk (e.g., kiosk 130b) an offer to deliver a second item that is within the inventory of the second kiosk (e.g., kiosk 130b) and, in response to the user accepting the offer, delivering the second item to the user from the second kiosk (e.g., kiosk 130b) to complete the order, where the second item is different than the first item) while being entirely devoid of any capability to perform any of the first through third enumerated operations.

By way of non-limiting example, the order handling module 114 may be configured to respond to the identification that the first item is not in the inventory of the second kiosk (e.g., kiosk 130b), by: 1) determining whether another item has at least one related characteristic to the first item which satisfies a defined rule is within the inventory of the second kiosk (e.g., kiosk 130b) (e.g., another movie/game by the same producer, actor(s), etc. as the reserved movie/game; another movie/game that is within the same genre (action/comedy/romance/etc.) as the reserved movie/game; another movie/game that has been observed by the kiosk 130 and/or by the order server 110 as being commonly selected by other users who also selected the reserved movie/game; and/or another movie/game that matches user's viewing tastes as determined from the user's previous movie/game rental/purchase history); 2) identifying the second item as being related to the first item; and 3) displaying the offer to deliver the second item to the user from the second kiosk (e.g., kiosk 130b) as a substitute order for the first item.

By further non-limiting example, the first item may be a first digital movie format (e.g., BlueRay format), and the order handling module 114 may be further configured to respond to the identification that the first item is not in the inventory of the second kiosk (e.g., kiosk 130b) by: 1) determining whether another item that has the related title to the first item but which has a different second digital movie format (e.g., DVD format) is within the inventory of the second kiosk; 2) identifying the second item as having the related title to the first item and the different second digital movie format; and 3) displaying (via the display device of the second kiosk) the offer to deliver the second item having the different second digital movie format to the user from the second kiosk (e.g., kiosk 130b) as a substitute order for the first item.

By another non-limiting example, the first item may be a movie media, and the order handling module 114 may be further configured to respond to the identification that the first item is not in the inventory of the second kiosk (e.g., kiosk 130b), by: 1) identifying other movies within the inventory of the second kiosk (e.g., kiosk 130b) that have related movie subject-matter characteristics to the first item; 2) displaying (via the display device of the second kiosk) the identified other movies to the user with an offer to deliver one of the displayed other movies from the inventory of the second kiosk (e.g., kiosk 130b) as a substitute order for the first item; and 3) responding to the user selecting the second item from among the displayed other movies to accept the offer, by delivering the second item to the user and cancelling the user's reservation for the first item at the first kiosk (e.g., kiosk 130a).

By another non-limiting example, the first item may be a video game configured to play on a first type of game console (e.g., Sony Playstation), and the order handling module 114 may be further configured to respond to the identification that the first item is not in the inventory of the second kiosk (e.g., kiosk 130b), by: 1) determining whether another item that has the video game title of the first item but is configured to play on a second type of game console (e.g., Microsoft X-Box) and is within the inventory of the second kiosk (e.g., kiosk 130b); 2) identifying the second item as having the related subject title to the first item and configured to play on the second type of game console; and 3) displaying the offer to deliver the second item having the configuration to play on the second type of game console to the user as a substitute order for the first item.

The order handling module 114 may be further configured to maintain the database 118 that identifies the inventory of the first kiosk (e.g., kiosk 130a) and second kiosk (e.g., kiosk 130b), where the first item is indicated by the database 118 to be within the inventory of the first kiosk (e.g., kiosk 130a). The order handling module 114 can respond to the order by updating the database 118 to indicate that the first item in the inventory of the first kiosk (e.g., kiosk 130a) is reserved for the user, and respond to the user accepting the offer to receive the second item at the second kiosk (e.g., kiosk 130b) by updating the database 118 to remove the second item from the inventory of the second kiosk (e.g., kiosk 130b) and to remove the user's reservation for the first item at the first kiosk (e.g., kiosk 130a).

It is to be further understood that the order handling module 114 may in still some other embodiments be configured to perform two or more of the first through fourth enumerated operations described above.

According to some embodiments, the order server 110 may respond to the user communications through the second kiosk (e.g., kiosk 130b) by communicating the address of the first kiosk (e.g., kiosk 130a) where the item is reserved for the user to pick-up, driving directions from the second kiosk (e.g., kiosk 130b) to the first kiosk (e.g., kiosk 130a), and/or an electronic map showing the relative locations of the first and second kiosks to a wireless electronic terminal (e.g., terminal 150) that is being carried by the user. Alternatively, when the user causes the order to be transferred from the first kiosk (e.g., kiosk 130a) to a third kiosk (e.g., kiosk 130n), the order server 110 may communicate the address of the third kiosk (e.g., kiosk 130n) where the item is now reserved for the user to pick-up, driving directions from the second kiosk (e.g., kiosk 130b) to the third kiosk (e.g., kiosk 130n), and/or an electronic map showing the relative locations of the second and third kiosks to a wireless electronic terminal (e.g., terminal 150) that is being carried by the user.

The user may enter a Short-Message-Service number (e.g., cell phone number), Multimedia Message Service number, electronic mail (E-mail) address, and/or other message address into the second kiosk where the user is presently located to cause the order server 110 to communicate a message/E-mail to the wireless electronic terminal that contains the address, driving directions, and/or electronic map to the user's wireless electronic terminal to facilitate the user's traveling to the kiosk location where the reserved item can be picked-up to complete the order. The order server 110 may be configured to retrieve the Short-Message-Service number (e.g., cell phone number), Multimedia Message Service number, electronic mail (E-mail) address, and/or other message address for use in communicating a message/E-mail to the wireless electronic terminal using the user's account information contained in the account information database 116 (when the user's has earlier registered that information for storage in the database 116).

Alternatively or additionally, the order server 110 may respond to a message and/or E-mail that is received from the user through the wireless electronic terminal, by communicating a message/E-mail to the wireless electronic terminal that contains the address, driving directions, and/or electronic map to the user's wireless electronic terminal to facilitate the user's traveling to the kiosk location where the reserved item can be picked-up to complete the order. Accordingly, the order server 110 may communicate the message/E-mail responsive to user instructions received via a kiosk operated by the user and/or via the user's wireless electronic terminal. While the user is traveling to a kiosk where the item is presently reserved, the user may send a message/E-mail to the order server 110 to cause the address of the kiosk, driving directions from the user's present location to the kiosk, and/or an electronic map that indicates the location of the kiosk and which may further indicate the relative location of the user and the kiosk, to be communicated to the user's wireless electronic terminal. The kiosks 130a-n may have an identifier that is printed or otherwise readable on the kiosk housing/display device, and the user may include the identifier in the message/E-mail sent to the order server 110 to identify the user's present location for use by the order server 110 in generating the communication.

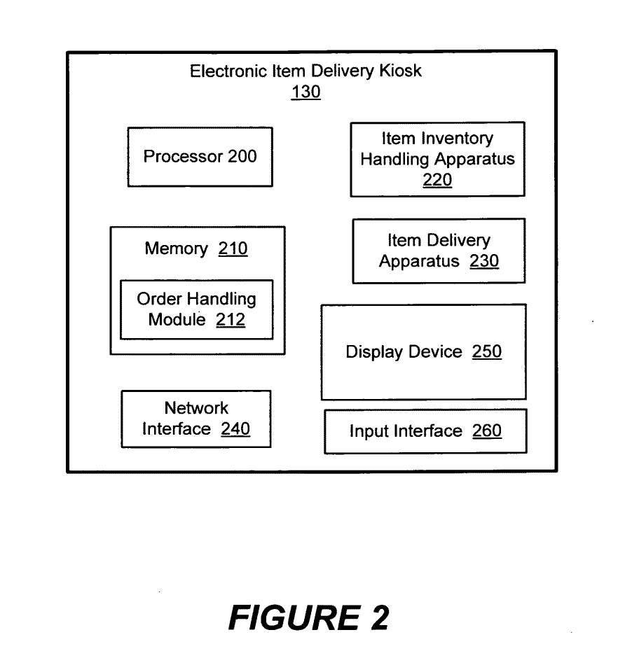

FIG. 2 is a block diagram of an example electronic item delivery kiosk 130, which may be replicated for use as the kiosks 130a-n in FIG. 1. The kiosk 130 can include a processor circuit 200, memory device(s) 210, an item inventory handling apparatus 220, an item delivery apparatus 230, a network interface 240, a display device 250, and a user input interface 260.

The display device 250 may include, but is not limited to, a liquid crystal display, a cathode ray tube, or any other display device. The user input interface 260 may include, but is not limited to, a keyboard, keypad, or touch sensitive layer overlaid or otherwise arranged to sense user touches on the display device 250.

The item delivery apparatus 230 may include, but is not limited to, a pick and place machine that can select among items that are stored in the item inventory handling apparatus 220, and transport the selected item for delivery to a user (e.g., through a slot or other opening in the kiosk 120) and/or transport an item received from the user for storage in the item inventory handling apparatus 220 for subsequent retrieval as part of another order.

The item inventory handling apparatus 220 may be, but is not limited, to an item storage rack that can retain items (e.g., disk-based movies/games/electronic devices/apparatuses) in an organized array (e.g., slots) for retrieval or storage by the handling apparatus 220.

The memory device(s) 210 contain functional modules, which may include an order handling module 212 that can perform operations for interfacing with users, interfacing with the order server 110, and controlling the item delivery apparatus 230 to delivery items from the handling apparatus 220 to a user and/or receiving and storing items received from a user in the handling apparatus 220. The processor circuit 220 may include one or more data processing circuits, such as a general purpose and/or special purpose processor (e.g., microprocessor and/or digital signal processor) with on-board and/or separate memory devices. The processor circuit 220 is configured to execute computer program instructions in the functional modules (e.g., order handling module 210) within the memory device(s) 210, which is described below as a computer readable medium, to operate as described herein. The network interface 240 is configured to communicate with the order server 110 through the network 140 and/or the radio access network(s) 142/144.

The order handling module 212 (which is assumed in this example embodiment to be within the above-described second kiosk 130b) may be configured to receive an order inquiry from a user via the user input interface. The order handling module 212 may be further configured to respond to a determination (which may be carried out by the order server 110) that the user placed an order to pick-up a first item from a first kiosk (e.g., kiosk 130a) that is geographically spaced apart from the second kiosk (e.g., kiosk 130b), by performing one of:

1) displaying to the user, through the display device, driving directions from the second kiosk to the first kiosk;

2) in response to the first item not being in the inventory of the second kiosk, identifying that a third kiosk has the first item within its inventory and displaying at the second kiosk a geographic location of the third kiosk;

3) in response to the first item being in the inventory of the second kiosk, delivering the first item from the second kiosk to the user to complete the order; or

4) in response to the first item not being in the inventory of the second kiosk, displaying at the second kiosk an offer to deliver a second item that is within the inventory of the second kiosk and, in response to the user accepting the offer, delivering the second item to the user to complete the order, wherein the second item is different than the first item.

As defined by the previous paragraph, the order handling module 212 performs at least one of the first through fourth enumerated operations. However, the order handling module 212 is not restricted to being capable of performing more than one of the first through fourth enumerated operations. Thus, it is to be understood that the order handling module 212 may be configured in one embodiment to perform the first enumerated operation while being entirely devoid of any capability to perform any of the second through fourth enumerated operations. In another embodiment, the order handling module 212 may be configured to perform the second enumerated operation while being entirely devoid of any capability to perform any of the first and third through fourth enumerated operations. In another embodiment, the order handling module 212 may be configured to perform the third enumerated operation while being entirely devoid of any capability to perform any of the first, second, and fourth enumerated operations. In another embodiment, the order handling module 212 may be configured to perform the fourth enumerated operation while being entirely devoid of any capability to perform any of the first, second, and third enumerated operations. In still another embodiment, the order handling module 212 may be configured to perform two or more of the first through fourth enumerated operations while being entirely devoid of any capability to perform any of the other enumerated operations.

For example, the order handling module 212 may be configured to display to the user, through the display device of the kiosk (e.g., second kiosk 130b) where the user is presently located, driving directions from that kiosk to another kiosk (e.g., first kiosk 130a) where the ordered first item is awaiting pick-up.

The order handling module 212 may be configured to identify that a third kiosk (e.g., kiosk 130n) has the first item within its inventory and to display at the second kiosk (e.g., kiosk 130b) a geographic location of the third kiosk (kiosk 130n). The order handling module 212 may be configured to offer to reserve the first item at the third kiosk (e.g., kiosk 130n) for pick-up by the user and, responsive to the user accepting the offer, to reserve the first item at the third kiosk (e.g., kiosk 130n) and to cancel the user's reservation for the first item at the first kiosk (e.g., kiosk 130a).

The order handling module 212 may be configured to identify that the first item is in the inventory of the second kiosk (e.g., kiosk 130b) and, responsive to the inventory identification, deliver the first item from the second kiosk (e.g., kiosk 130b) to the user and to cancel the user's reservation for the first item at the first kiosk (e.g., kiosk 130a).

The order handling module 212 may be configured to identify that the first item is not in the inventory of the second kiosk (e.g., kiosk 130b) and, responsive to the inventory identification, display to the user through the display device an offer to deliver a second item that is within the inventory of the second kiosk (e.g., kiosk 130b) and, in response to the user accepting the offer, to deliver the second item to the user from the second kiosk (e.g., kiosk 130b) and to cancel the user's reservation for the first item at the first kiosk (e.g., kiosk 130a).

The order handling module 212 may be configured to respond to the identification that the first item is not in the inventory of the second kiosk (e.g., kiosk 130b), by: 1) determining whether another item has at least one related characteristic to the first item which satisfies a defined rule is within the inventory of the second kiosk (e.g., kiosk 130b) (e.g., another movie/game by the same producer, actor(s), etc. as the reserved movie/game; another movie/game that is within the same genre (action/comedy/romance/etc.) as the reserved movie/game; another movie/game that has been observed by the second kiosk 130b and/or by the order server 110 as being commonly selected by other users who also selected the reserved movie/game; and/or another movie/game that matches user's viewing tastes as determined from the user's previous movie/game rental/purchase history); 2) identifying the second item as having a related characteristic to the first item that satisfies the defined rule; 3) displaying the offer to deliver the second item to the user from the second kiosk (e.g., kiosk 130b); and 4) in response to the user accepting the offer, delivering the second item to the user from the second kiosk (e.g., kiosk 130b) and cancelling the user's reservation for the first item at the first kiosk (e.g., kiosk 130a).

By way of non-limiting example, the first item may be a first digital movie format (e.g., BlueRay format), and the order handling module 212 may be further configured to respond to the identification that the first item is not in the inventory of the second kiosk, by: 1) determining whether another item that has a related title to the first item but which has a different second digital movie format (e.g., DVD format) is within the inventory of the second kiosk; 2) identifying the second item as having the related title to the first item and the different second digital movie format; and 3) displaying the offer to deliver the second item having the different second digital movie format to the user from the second kiosk as a substitute order for the first item.

By way of another non-limiting example, the first item may be a video game media. The order handling module 212 may be further configured to respond to the identification that the first item is not in the inventory of the second kiosk, by: 1) determining whether another video game media that has related subject matter features to the first item video game media is within the inventory of the second kiosk; and 2) identifying the second item video game media as having the related subject matter features to the first item video game media, and displaying the offer to deliver the second item video game media to the user from the second kiosk as a substitute order for the first item video game media.

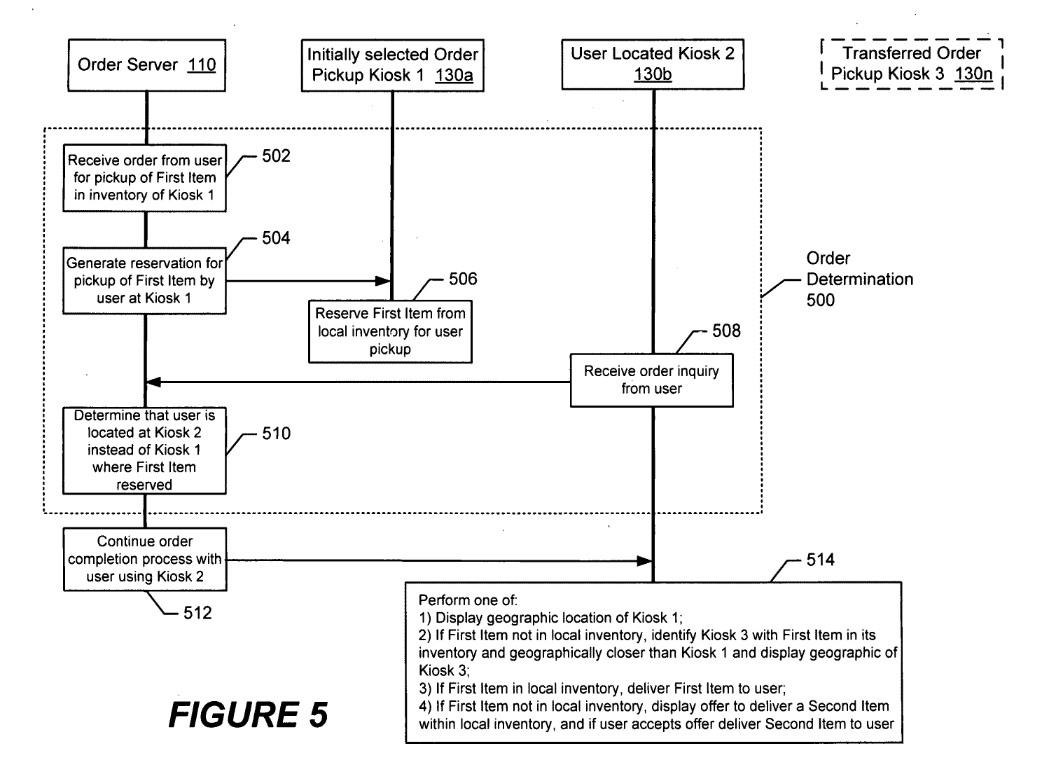

FIG. 5 illustrates an operation and communication flow diagram that shows example operations and methods that may be performed by the order handling system 100 of FIG. 1 or another order handling system, according to some embodiments of the present invention. Referring to FIG. 5, the order server 110 receives (block 502) an order from a user to pick-up a first item is within the inventory of a first kiosk 130a. The order server 110 generates (block 504) a reservation for the first item to be picked up by the user at the first kiosk 130a. The order server 110 may communicate (block 506) the reservation to the first kiosk 130a and/or may update the kiosk inventory database 118 to reflect that first item is reserved for pick-up by the user at the first kiosk 130a.

Instead of arriving at the first kiosk 130a, the user arrives at the second kiosk 130b. The second kiosk 130b receives (block 508) an order inquiry for the first item from the user. The second kiosk 130b communicates the order inquiry to the order server 110, which determines (block 510) that the user is located at the second kiosk 130b instead of at the first kiosk 130a where the first item has been reserved.

The operations of blocks 502 through 510 are referred to herein as order determination operations 500 for ease of reference.

The order server 110 communicates with the user through the second kiosk 130b to facilitate completion of the order. In accordance with some embodiments, the order server 110 operates in conjunction with the second kiosk 130b to perform at least one of the following operations:
1) displaying geographic location of the first kiosk 130a;
2) determine that the first item is not in the inventory of the second kiosk 130b and, responsive thereto, identify that the third kiosk 130n has the first item in its inventory is geographically closer than the first kiosk 130b and, responsive thereto, display the geographic location of the third kiosk 130n;
3) determine that the first item is in the inventory of the second kiosk 130b and, responsive thereto, deliver the first item to the user from the local inventory of the second kiosk 130b; and/or
4) determine that the first item is not in the local inventory of the second kiosk 130b and, responsive thereto, to display an offer to deliver a second item that is within the local inventory the second kiosk 130b and, if the user accepts the offer, to deliver the second item to the user from the local inventory of the second kiosk 130b to complete the order.

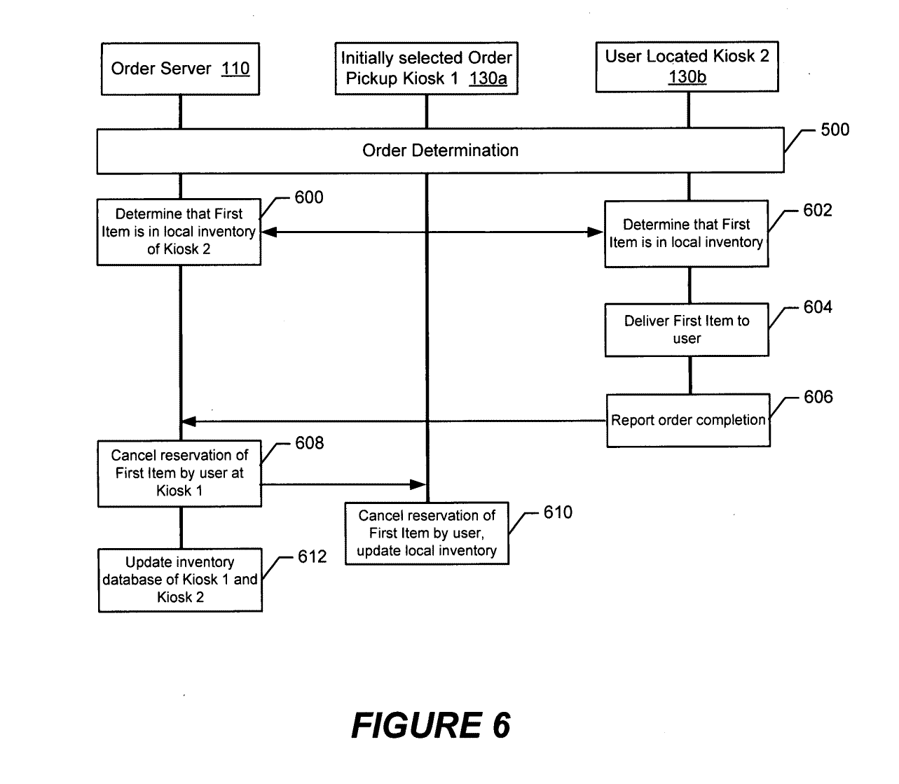

FIG. 6 illustrates an operation and communication flow diagram that shows example operations and methods that may be performed by the order handling system 100 of FIG. 1 in combination with the operations and methods of FIG. 5 to transfer an order by a user to pick-up a first item at a first kiosk to instead pick-up the first item at a second kiosk to complete the order, according to some embodiments of the present invention. Referring to FIG. 6, the order determination operations 500 described above for FIG. 5 are performed.

The order server 110 determines (block 600) that the first item is in the local inventory of the second kiosk 130b and/or the second kiosk 130b determines (block 602) (by itself without requiring assistance from the order server 110) that the first item is in the local inventory of the second kiosk 130b. The second kiosk 130b delivers (block 604) the first item to the user, and reports (block 606) completion of the order to the order server 110. The order server 110 responds to the report by canceling (block 608) the reservation for the first item at the first kiosk 130a. The order server 110 may communicate the cancellation of the reservation to the first kiosk 130a (when the first kiosk 130a maintains its own inventory database) and/or may update the kiosk inventory database 118 to cancel (block 612) the reservation for the first item for pick-up by the user at the first kiosk 130a (when the order server 110 maintains the inventory of each of the kiosk 130a-n). When the first kiosk 130a maintains its own inventory and associated reservations, the first kiosk 130a can respond to the indication from the order server 110 by canceling (block 610) the reservation for the first item for pick-up by the user.

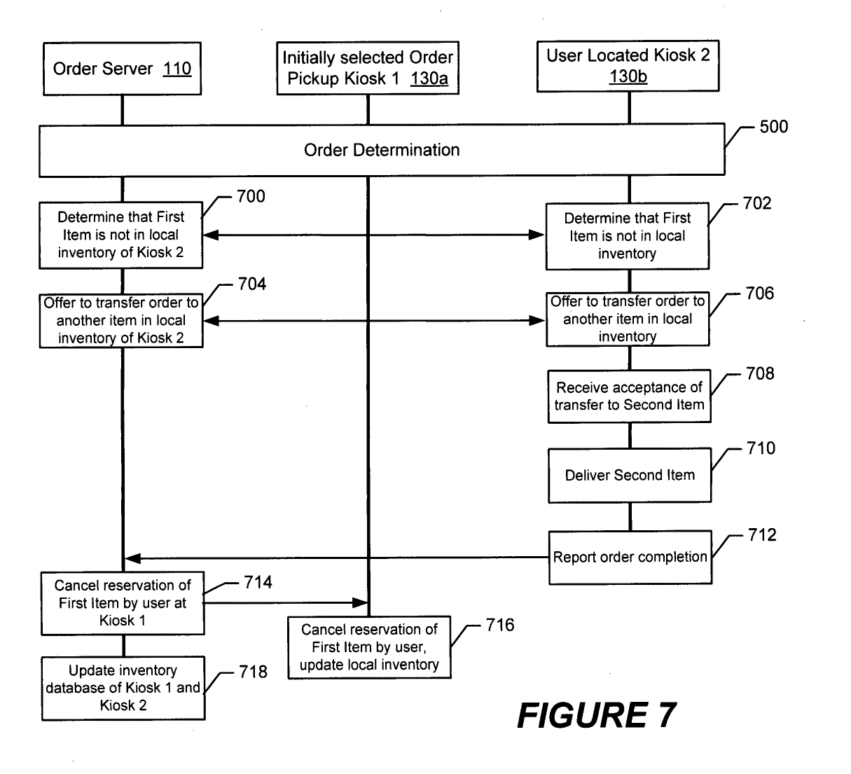

FIG. 7 illustrates an operation and communication flow diagram that shows example operations and methods that may be performed by the order handling system 100 of FIG. 1 in combination with the operations and methods of FIG. 5 to transfer an order by a user to pick-up a first item at a first kiosk to instead picked up a different second item at a second kiosk to complete the order, according to some embodiments of the present invention. Referring to FIG. 7, the order determination operations 500 described above for FIG. 5 are performed.

The order server 110 determines (block 700) that the first item is not in the local inventory of the second kiosk 130b and/or the second kiosk 130b determines (block 702) (by itself without requiring assistance from the order server 110) that the first item is not in the local inventory of the second kiosk 130b. The order server 110 then displays (block 704) an offer to the user (via the display device of the second kiosk 130b) to select another item (which is different than the first item) for delivery from the local inventory of the second kiosk 130b, and/or the second kiosk 130b may display (block 706) the offer without requiring assistance from the order server 110.

The second kiosk 130b receives (block 708) acceptance of the offer from the user and, responsive thereto, delivers (block 710) the second item to the user and reports (block 712) completion of the order to the order server 110. The order server 110 cancels (block 714) reservation for the first item to the user at the first kiosk 130a, and/or may communicate the cancellation notification to the first kiosk 130a (when the first kiosk 130a maintains an accounting of its own reservations and local inventory) to allow the first kiosk 130a to cancel (block 716) the reservation and update its local inventory. The order server 110 can update (block 718) inventory database 118 of the first kiosk 130a and the second kiosk 130b.

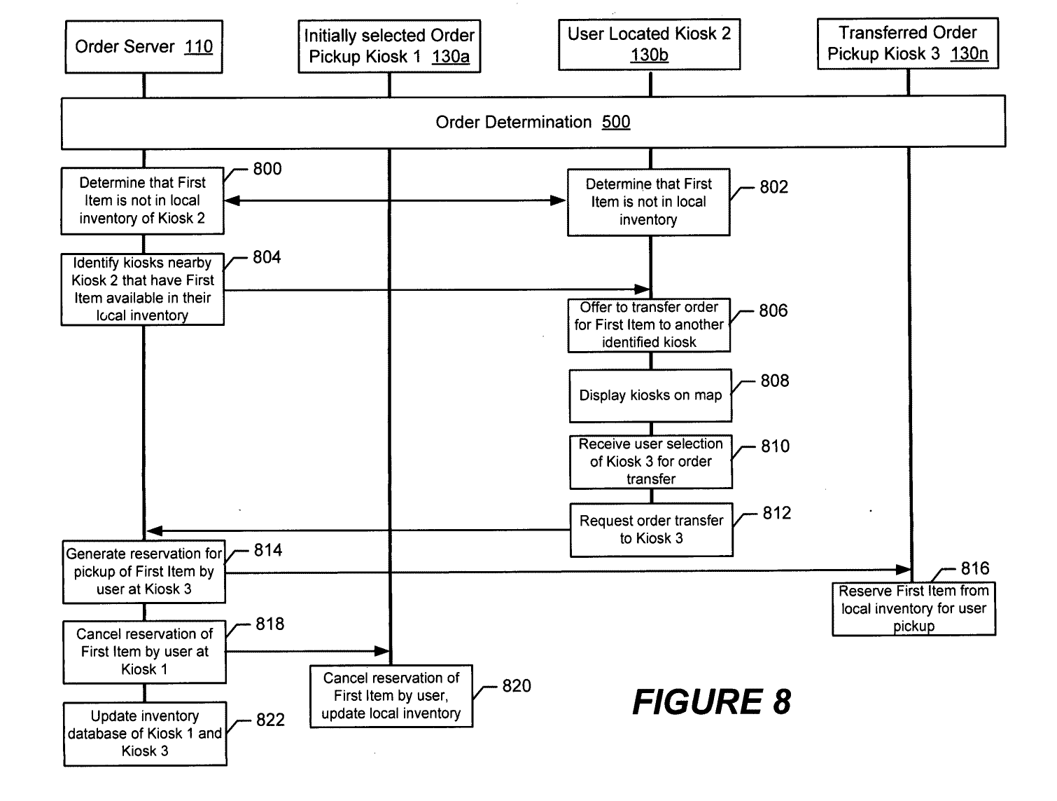

FIG. 8 illustrates an operation and communication flow diagram that shows example operations and methods that may be performed by the order handling system 100 of FIG. 1 in combination with the operations and methods of FIG. 5 to transfer an order by a user to pick-up a first item at a first kiosk to instead pick-up the first item at a third kiosk, which is separate from a second kiosk where the user is presently located, to complete the order, according to some embodiments of the present invention. Referring to FIG. 8, the order determination operations 500 described above for FIG. 5 are performed.

The order server 110 determines (block 800) that the first item is not in the local inventory of the second kiosk 130b and/or the second kiosk 130b determines (block 802) (by itself without requiring assistance from the order server 110) that the first item is not in the local inventory of the second kiosk 130b. The order server 110 then identifies (block 804) at least one other kiosk that is relatively nearby the second kiosk 130b (where the user is presently located) that has the first item within its local inventory, and operates in cooperation with the second kiosk 130b to display (block 806) an offer to the user (via the display device of the second kiosk 130b) to transfer the order for the first item to the other identified kiosk. The location of the other kiosk(s) may be displayed (block 808) on a map. A user selection of another kiosk (e.g., third kiosk 130n) is received (block 810) in which the user wants the order transferred to the other kiosk to allow the user to pick-up the first item from the other kiosk to complete the order. The user selection is communicated (block 812) to the order server 110. The order server 110 may generate (block 814) a reservation for the first item to be picked-up by the user from the inventory of the other kiosk, and may communicate the reservation to the other kiosk (e.g., third kiosk 130n) when the third kiosk maintains an accounting of its own reservations and local inventory. The order server 110 may cancels (block 818) the reservation for the user to pick-up the first item at the first kiosk (e.g., kiosk 130a), and updates (block 822) the inventory of the first kiosk 130a and the other kiosk (e.g., third kiosk 130n). The order server 110 may communicate the order cancellation to the first kiosk (e.g., kiosk 130a) to cause the first kiosk to cancel (block 82) the reservation, when the first kiosk maintains an accounting of its own reservations and local inventory.

In the above-description of various embodiments of the present invention, it is to be understood that the terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of this specification and the relevant art and will not be interpreted in an idealized or overly formal sense expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Exemplary embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks.

A tangible, non-transitory computer-readable medium may include an electronic, magnetic, optical, electromagnetic, or semiconductor data storage system, apparatus, or device. More specific examples of the computer-readable medium would include the following: a portable computer diskette, a random access memory (RAM) circuit, a read-only memory (ROM) circuit, an erasable programmable read-only memory (EPROM or Flash memory) circuit, a portable compact disc read-only memory (CD-ROM), and a portable digital video disc read-only memory (DVD/BlueRay).

The computer program instructions may also be loaded onto a computer and/or other programmable data processing apparatus to cause a series of operational steps to be performed on the computer and/or other programmable apparatus to produce a computer-implemented process such that the instructions which execute on the computer or other programmable apparatus provide steps for implementing the functions/acts specified in the block diagrams and/or flowchart block or blocks.

Accordingly, embodiments of the present invention may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated. Moreover, although some of the diagrams include arrows on communication paths to show a primary direction of communication, it is to be understood that communication may occur in the opposite direction to the depicted arrows.

Many different embodiments have been disclosed herein, in connection with the above description and the drawings. It will be understood that it would be unduly repetitious and obfuscating to literally describe and illustrate every combination and subcombination of these embodiments. Accordingly, the present specification, including the drawings, shall be construed to constitute a complete written description of various exemplary combinations and subcombinations of embodiments and of the manner and process of making and using them, and shall support claims to any such combination or subcombination.

Many variations and modifications can be made to the embodiments without substantially departing from the principles of the present invention. All such variations and modifications are intended to be included herein within the scope of the present invention.

What is claimed:

1. An order handling system comprising:
a network interface that is configured to communicate through a wide area network; and
an order handling module that is configured to:
receive, via the network interface, an order from a user for a first item that is within the inventory of a first kiosk;
reserve the first item for pick-up by the user at the first kiosk in response to the order;
receive from a second kiosk an order inquiry from the user, wherein the second kiosk is geographically spaced apart from the first kiosk;
determine that the user is located at the second kiosk instead of at the first kiosk where the first item is reserved; and
responsive to the determination that the user is located at the second kiosk, carrying out through the second kiosk one of:
1) displaying to the user, through the second kiosk, a geographic location of the first kiosk;
2) in response to the first item not being in the inventory of the second kiosk, identifying that a third kiosk has the first item within its inventory and displaying at the second kiosk a geographic location of the third kiosk;
3) in response to the first item being in the inventory of the second kiosk, delivering the first item from the second kiosk to the user to complete the order; and/or
4) in response to the first item not being in the inventory of the second kiosk, displaying at the second kiosk an offer to deliver a second item that is within the inventory of the second kiosk and, in response to the user accepting the offer, delivering the second item to the user to complete the order, wherein the second item is different than the first item.

2. The order handling system of claim 1, wherein:
the order handling module is configured to display to the user, through the second kiosk, geographic locations of the first and second kiosks relative to an electronic map.

3. The order handling system of claim 2, wherein;
the order handling module is further configured to identify that the first item is not in the inventory of the second kiosk, and to respond to the inventory identification and to the determination that the user is located at the second kiosk by displaying at the second kiosk to the user driving directions from the second kiosk to the first kiosk.

4. The order handling system of claim 1, wherein:
the order handling module is configured to identify that the third kiosk has the first item within its inventory and is nearby the second kiosk, and, responsive to the identification, to display at the second kiosk a geographic location of the third kiosk.

5. The order handling system of claim 4, wherein:
the order handling module is further configured to display to the user, through the second kiosk, driving directions from the second kiosk to the third kiosk.

6. The order handling system of claim 4, wherein:
the order handling module is further configured to offer to reserve the first item at the third kiosk for pick-up by the user and, responsive to the user accepting the offer, to reserve the first item at the third kiosk and to cancel the user's reservation for the first item at the first kiosk.

7. The order handling system of claim 1, wherein:
the order handling module is configured to identify that the first item is in the inventory of the second kiosk and, responsive to the inventory identification, deliver the first item from the second kiosk to the user and to cancel the user's reservation for the first item at the first kiosk.

8. The order handling system of claim 7, wherein the order handling module is further configured to:
maintain a database that identifies the inventory of the first and second kiosks, wherein the first item is indicated by the database to be within the inventory of the first kiosk and to be within the inventory of the second kiosk;
respond to the order by updating the database to indicate that the first item in the inventory of the first kiosk is reserved for the user; and
respond to delivery of the first item from the second kiosk to the user by updating the database to remove the first item from the inventory of the second kiosk and to remove the user's reservation for the first item at the first kiosk.

9. The order handling system of claim 1, wherein:
the order handling module is configured to identify that the first item is not in the inventory of the second kiosk and, responsive to the inventory identification, display to the user through the second kiosk an offer to deliver a second item that is within the inventory of the second kiosk and, in response to the user accepting the offer, to deliver the second item to the user and to cancel the user's reservation for the first item at the first kiosk.

10. The order handling system of claim 9, wherein the order handling module is further configured to:
respond to the identification that the first item is not in the inventory of the second kiosk, by:
determining whether another item has at least one related characteristic to the first item which satisfies a defined rule is within the inventory of the second kiosk;
identifying the second item as having a related characteristic to the first item that satisfies the defined rule; and
displaying the offer to deliver the second item to the user from the second kiosk as a substitute order for the first item.

11. The order handling system of claim 10, wherein:
the first item is a first digital movie format; and
the order handling module is further configured to respond to the identification that the first item is not in the inventory of the second kiosk, by:
determining whether another item that has the related title to the first item but which has a different second digital movie format is within the inventory of the second kiosk;
identifying the second item as having the related title to the first item and the different second digital movie format; and
displaying the offer to deliver the second item having the different second digital movie format to the user from the second kiosk as a substitute order for the first item.

12. The order handling system of claim 9, wherein:
the first item is a movie media; and
the order handling module is further configured to respond to the identification that the first item is not in the inventory of the second kiosk, by:
identifying other movies within the inventory of the second kiosk that have related movie subject-matter characteristics to the first item;
displaying the identified other movies to the user with an offer to deliver one of the displayed other movies from the inventory of the second kiosk as a substitute order for the first item; and
responding to the user selecting the second item from among the displayed other movies to accept the offer, by delivering the second item to the user and cancelling the user's reservation for the first item at the first kiosk.

13. The order handling system of claim 9, wherein:
the first item is a video game configured to play on a first type of game console; and
the order handling module is further configured to respond to the identification that the first item is not in the inventory of the second kiosk, by:
determining whether another item that has the video game title of the first item but is configured to play on a second type of game console and is within the inventory of the second kiosk;
identifying the second item as having the related subject title to the first item and configured to play on the second type of game console; and
displaying the offer to deliver the second item having the configuration to play on the second type of game console to the user as a substitute order for the first item.

14. The order handling system of claim 9, wherein the order handling module is further configured to:
maintain a database that identifies the inventory of the first and second kiosks, wherein the first item is indicated by the database to be within the inventory of the first kiosk;
respond to the order by updating the database to indicate that the first item in the inventory of the first kiosk is reserved for the user; and
respond to the user accepting the offer to receive the second item at the second kiosk by updating the database to remove the second item from the inventory of the second kiosk and to remove the user's reservation for the first item at the first kiosk.

15. The order handling system of claim 1, wherein:
the first and second kiosks contain movies and/or video game media, and each of the first and second kiosks are configured to reserve a selected movie and/or video game media from a local inventory for pick-up by a user in response to instructions from the order handling module, and to deliver the reserved movie and/or video game media from the local inventory to the user.

16. A first kiosk comprising:
a network interface that is configured to communicate through a wide area network;
a display device;
a user input interface;
an item inventory handling apparatus that is configured to organize a plurality of items;
an item delivery apparatus that is configured to receive items from some users and store the received items in the item inventory handling apparatus, and to delivery items from the item inventory handling apparatus to other users; and
an order handling module that is configured to:
receive an order inquiry from a user via the user input interface; and
respond to a determination that the user placed an order to pick-up a first item from a second kiosk that is geographically spaced apart from the first kiosk, by performing one of:
1) displaying to the user, through the display device, driving directions from the first kiosk to the second kiosk;
2) in response to the first item not being in the inventory of the first kiosk, identifying that a third kiosk has the first item within its inventory and displaying at the first kiosk a geographic location of the third kiosk;
3) in response to the first item being in the inventory of the first kiosk, delivering the first item from the first kiosk to the user to complete the order; and/or
4) in response to the first item not being in the inventory of the first kiosk, displaying at the first kiosk an offer to deliver a second item that is within the inventory of the first kiosk and, in response to the user accepting the offer, delivering the second item to the user to complete the order, wherein the second item is different than the first item.

16. The first kiosk of claim 15, wherein:
the order handling module is configured to display to the user, through the display device, driving directions from the first kiosk to the second kiosk;

17. The first kiosk of claim 15, wherein:
the order handling module is configured to identify that the third kiosk has the first item within its inventory and to display at the second kiosk a geographic location of the third kiosk.

18. The first kiosk of claim 17, wherein:
the order handling module is further configured to offer to reserve the first item at the third kiosk for pick-up by the user and, responsive to the user accepting the offer, to reserve the first item at the third kiosk and to cancel the user's reservation for the first item at the second kiosk.

19. The first kiosk of claim 15, wherein:
the order handling module is configured to identify that the first item is in the inventory of the first kiosk and, responsive to the inventory identification, deliver the first item from the first kiosk to the user and to cancel the user's reservation for the first item at the second kiosk.

20. The first kiosk of claim 15, wherein:
the order handling module is configured to identify that the first item is not in the inventory of the first kiosk and, responsive to the inventory identification, display to the user through the display device an offer to deliver a second item that is within the inventory of the first kiosk and, in response to the user accepting the offer, to deliver the second item to the user from the first kiosk and to cancel the user's reservation for the first item at the second kiosk.

21. The first kiosk of claim 15, wherein:
the order handling module is further configured to respond to the identification that the first item is not in the inventory of the first kiosk, by:
determining whether another item has at least one related characteristic to the first item which satisfies a defined rule is within the inventory of the first kiosk;
identifying the second item as having a related characteristic to the first item that satisfies the defined rule;
displaying the offer to deliver the second item to the user from the first kiosk; and
in response to the user accepting the offer, delivering the second item to the user from the first kiosk and cancelling the user's reservation for the first item at the second kiosk.

22. The first kiosk of claim 15, wherein:
the first item is a first digital movie format; and
the order handling module is further configured to respond to the identification that the first item is not in the inventory of the first kiosk, by:
determining whether another item that has a related subject title to the first item but which has a different second digital movie format is within the inventory of the first kiosk;
identifying the second item as having the related subject title to the first item and the different second digital movie format; and
displaying the offer to deliver the second item having the different second digital movie format to the user from the first kiosk as a substitute order for the first item.

23. The first kiosk of claim 15, wherein:
the first item is a video game media; and
the order handling module is further configured to respond to the identification that the first item is not in the inventory of the first kiosk, by:
determining whether another video game media that has related subject matter features to the first item video game media is within the inventory of the first kiosk;
identifying the second item video game media as having the related subject matter features to the first item video game media, and displaying the offer to deliver the second item video game media to the user from the first kiosk as a substitute order for the first item video game media.
